(19) United States
(12) Patent Application Publication
(10) Pub. No.: US 2008/0168633 A1
(43) Pub. Date: Jul. 17, 2008

(54) Elastic fastener and actuator module using the same

(75) Inventors: Byoung-Soo Kim, Seoul (KR); Jung-Ho Lee, Seoul (KR)

Correspondence Address: GWIPS;Peter T. Kwon, Gwacheon P.O. Box 72, 119 Byeolyang Ro, Gwacheon City, Gyeonggi-Do, 427-600, omitted

(73) Assignee: Robotis Co., Ltd.

(21) Appl. No.: 12/007,611

(22) Filed: Jan. 14, 2008

(30) Foreign Application Priority Data
Jan. 12, 2007 (KR) 10-2007-0003762
Jan. 12, 2007 (KR) 10-2007-0003770

(51) Int. Cl. A44B 17/00; F16B 5/00

(52) U.S. Cl. 24/572.1; 403/408.1

(57) ABSTRACT

An elastic fastener has developed to be assembled and disassembled easily, even without the use of a separate tool, that can be firmly and repeatedly coupled, and an actuator module using the same. The elastic fastener includes a hollow socket adapted to be elastically inserted into insertion holes formed on joint members, and a fixing pin coupled to a hollow portion of the hollow socket. The actuator module includes a housing including a first lateral plate having at least one insertion hole for inserting an elastic fastener, a second lateral plate positioned to face the first lateral plate and provided with at least one insertion hole of an identical shape as the insertion hole of the first lateral plate, and two lateral surfaces positioned between both ends of the first and second lateral plates while facing each other; a first connection member coupled to a driving shaft of an actuator contained in the housing via the first lateral plate, the first connection member having at least one insertion hole of an identical shape as the insertion holes of the first and second lateral plates, the first connection member having a flat plate shape; and an elastic fastener including a hollow socket adapted to be elastically inserted into the insertion hole formed in the first connection member and a fixing pin coupled to the hollow portion of the hollow socket.

### BACKGROUND OF THE INVENTION

1. Field of the Invention

The present invention relates to an elastic fastener and an actuator module using the same. More particularly, the elastic fastener is designed to be easily, firmly and repeatedly assembled and disassembled without tools and the actuator module is capable of being coupled universally by making use of the elastic fastener.

2. Description of the Prior Art

As generally known in the art, bolts and nuts are the typical conventional fasteners for fastening at least two members to each other. Bolts and nuts have a structure simple enough to be fabricated easily, and are firmly coupled to the joint members.

However, bolts and nuts have a problem in that a separate tool, such as a spanner wrench, is necessary to fasten them to each other. In addition, when repeatedly fastened and unfastened, the friction between the bolt head and the tool wears down the bolt head.

Furthermore, when bolts and nuts made of a material with low hardness (e.g. plastic) are repeatedly fastened and unfastened, or when bolts and nuts made of metal are used to fasten joint members made of a low-hardness material, it is inevitable that the threads are worn down and damaged, or that plastic debris is created.

In addition, if joint members fastened by bolts and nuts undergo persistent impact, if the joint members are supposed to undergo repeated motions, or if the bolts and nuts are made of a material with insufficient hardness, the bolts and nuts may be loosened or even unfastened.

In particular, in the case of model robots or toy blocks, a number of joint members need to be multiply coupled to complete the robot or toy in the desired shape. This requires that the joint members are coupled repeatedly and multiply while being able to rotate.

However, bolts and nuts always fixedly couple joint members to each other, and cannot be used to couple joint members which are supposed to rotate in opposite directions while remaining coupled to each other.

Furthermore, bolts and nuts cannot be used to stack three or more layers of joint members and to couple each adjacent pair of members. More particularly, bolts and nuts are not suited to a structure wherein joint members of the first and second layers are coupled to each other, a third-layer joint member is placed on the second-layer joint member and coupled only to it, and a fourth-layer joint member is placed on the third-layer joint member and coupled only to it, etc., because bolts protrude from the surface of the joint members and make it impossible to stack another joint member on top of it.

As such, bolts and nuts cannot be used to extend or enlarge a multiply-coupled structure by stacking at least three layers of joint members and coupling the adjacent pairs of members.

Therefore, a new fastener structure capable of solving the above-mentioned problems is necessary.

Meanwhile, in contrast to industrial robots, personal robots are used to provide various services in homes, medical institutes, nursing facilities, etc. The personal robots include entertainment robots, which are adapted for playing, which can move on their own, which have shapes similar to those of humans or animals, and which have a psychotherapeutic effect. In other words, entertainment robots can be used in various fields including playing, psychotherapy, education, etc.

Typical examples of entertainment robots include “Aibo” from Sony Corp., “Paro”, shaped like a harp seal and adapted for psychotherapy, and other types of small entertainment robots.

These small entertainment robots conventionally have a single shape and a specific function based on specifications determined by the manufacturer, just like conventional domestic electronic products (e.g. TV sets and refrigerators). More particularly, when a person buys a robot, he/she does not expect more than its predetermined function and shape, just like a person buying a TV set does not expect the function and shape of a refrigerator.

In contrast, personal computers (PCs), which may even be regarded as domestic electronic products, have fairly different roles from those of conventional domestic electronic products due to their unique degree of freedom, extendability, and compatibility. In line with the development of software and peripheral devices, PCs can now play the roles of TV sets, VCRs, MP3 players, cameras, etc.

In this regard, if personal robots are given the same degree of freedom, extendability, and compatibility as in the case of PCs, users can implement robots which can substantially change their shapes on their own and which can continually conduct new operations.

There have been attempts to give robots extendability and compatibility by combining extendable actuator modules with connection members to construct a robot, but the non-standardized structure of actuator modules and connection members limits free connection and extension.

Bolts and nuts have been conventionally employed as fastening means for connecting or coupling components of robots, but such conventional fastening means make it difficult to freely transmit rotational force between components. In addition, bolts and nuts cannot be fastened without a separate tool (e.g. wrenches), and when repeatedly fastened and unfastened, the friction between the bolt head and the tool wears down the bolt head.

Furthermore, when actuator modules and connection members are made of plastic and when bolts and nuts correspondingly made of a material with low hardness (e.g. plastic) are repeatedly fastened and unfastened, or when bolts made of metal are coupled to joint members made of a low-hardness material, it is inevitable that the threads are worn down and damaged, or that plastic debris is created, as mentioned above.

In addition, if joint members fastened by bolts and nuts undergo persistent impact, or if the joint members are supposed to undergo repeated motions, or if the bolts and nuts are made of a material with insufficient hardness, the bolts and nuts may be loosened or even unfastened.

Considering that bolts and nuts always fixedly couple joint members to each other, they cannot be used to couple joint members which are supposed to rotate in opposite directions while remaining coupled to each other, as in the case of robot joints.

Furthermore, both surfaces of the joint members must be exposed to fasten them by bolts and nuts. As a result, bolts and nuts cannot be used to extend or enlarge a multiply-coupled structure by stacking multiple layers of joint members and coupling the adjacent pairs of members.

### SUMMARY OF THE INVENTION

Accordingly, the present invention has been made to solve the above-mentioned problems occurring in the prior art, and the present invention provides a new type of fastener adapted to be assembled and disassembled easily without a separate tool, and to be firmly and repeatedly reused without causing the fastener itself or joint members to wear down or fracture.

The present invention also provides an elastic fastener including a hollow socket inserted into the insertion holes of the joint members and a fixing pin additionally inserted into the hollow portion of the socket so that the elastic fastener does not separate from the joint members unintentionally.

The present invention also provides an elastic fastener including a socket having a smooth outer surface so that joint members are firmly fastened to each other while being able to rotate.

The present invention also provides an elastic fastener adapted to multiply fasten a number of joint members.

The present invention also provides an elastic fastener adapted to fasten joint members having a number of insertion holes which are symmetric about the midplane of the thickness of the member, and which are arrayed in a uniform lattice.

The present invention also provides an elastic fastener having the above-mentioned characteristics so that it is useful for model robots, toy blocks, etc.

In order to satisfy the above-mentioned requirements, the present invention also provides an actuator module applicable to model robots, operable toy blocks, etc. and adapted to provide a robot solution having a high degree of freedom, extendability, and compatibility so that the user can modify and upgrade the robot by himself/herself.

The present invention also provides an actuator module having a universal coupling structure, i.e. one that is capable of establishing a repeated coupling structure much more efficiently than with conventional coupling means (e.g. bolts and nuts), by forming insertion holes on the actuator module and the connection member in a standardized manner and providing elastic fasteners adapted to be coupled to the insertion holes efficiently.

The present invention also provides an actuator module having a universal coupling structure so that, by introducing a new design of each part of the actuator module housing, not only can the actuator module and the connection member be assembled and coupled easily, but also the wiring can be properly handled when components are coupled.

The present invention also provides an actuator module including hollow sockets inserted into the insertion holes ofjoint members and fixing pins additionally inserted into the hollow portions of the sockets so that the elastic fasteners do not separate from the joint members unintentionally, guaranteeing stable operation of the robot.

The present invention also provides an actuator module including a socket having a smooth outer surface so that joint members are firmly fastened to each other while being able to rotate.

The present invention also provides an actuator module and a connection member including a frame having a number of insertion holes which are symmetric about the midplane of the frame's thickness, and which are standardized and arrayed in a uniform lattice.

The present invention also provides an actuator module and a connection module having the above-mentioned characteristics so that they are useful for model robots, operable toy blocks, etc.

In accordance with an aspect of the present invention, there is provided an elastic fastener including a hollow socket adapted to be elastically inserted into an insertion hole formed in the joint members, and a fixing pin coupled to a hollow portion of the hollow socket.

The fixing pin includes a head and a shaft extending along a central axis of the head, and the hollow socket includes a hollow tube having a length corresponding to the depth of the insertion holes in the joint members and at least two flexibility enhancing slots extending from a given axial location on the hollow tube to one end of the hollow tube so that fingers are formed on the end of the hollow tube.

The hollow socket further includes a split latching ledge formed on the end of the hollow tube that is divided into fingers by the slot(s), and an integral latching ledge formed on the other end of the hollow tube. The hollow tube has at least two flexibility enhancing slots formed thereon.

Alternatively, the hollow socket may further include fingers and split latching ledges formed on both ends of the hollow tube, and an integral latching ledge formed at a predetermined location between the two ends of the hollow tube. The hollow tube has at least two flexibility enhancing slots formed thereon.

At least one latching groove is formed on a surface of the shaft of the fixing pin, and at least one latching ridge is formed on an inner surface of the socket, such that the latching ridge corresponds to and mates with the latching groove.

The integral and split latching ledges of the socket have chamfers formed on their inner ends. The connection portion between the head and the shaft of the fixing pin also has a chamfer, and the tip of the shaft has a chamfer. These chamfers correspond to the chamfers of the integral and split latching ledges, respectively, so that the fixing pin and the socket are forced against and coupled to each other.

The socket and the fixing pin are made of an elastic material. The shaft of the fixing pin has a geometric structure corresponding to that of the hollow portion of the socket.

The elastic fastener is adapted to fasten joint members having a number of insertion holes arrayed in a uniform lattice, the insertion holes being symmetric about the midplane of the thickness of the member. The socket and the fixing pin are adapted to be inserted into the insertion holes from the same direction when coupling the joint members. The socket and the fixing pin are adapted so that the joint members can rotate about the central axis of the socket and the fixing pin when the socket and the fixing pin are coupled to the joint members.

The joint members have seating portions formed by indenting a frame portion near respective insertion holes at a predetermined depth. The integral and split latching ledges of the socket are adapted to be coupled to the seating portions of the joint members when the socket is coupled to the joint members. The seating portions have a depth corresponding to the height of the integral and split latching ledges of the socket, and the socket is designed to be flush with the surface of the joint members when the socket couples at least two joint members to each other.

The head of the fixing pin is adapted to stand proud of the surface of the upper joint member when the fixing pin is coupled to the socket, which is coupled to the joint members. The head of the fixing pin has a height corresponding to the depth of the seating portions of the joint members.

In accordance with another aspect of the present invention, there is provided an actuator module including a housing including a first lateral plate having at least one insertion hole for inserting an elastic fastener, a second lateral plate positioned to face the first lateral plate and provided with at least one insertion hole of an identical shape as the insertion hole of the first lateral plate, and two lateral surfaces positioned between both ends of the first and second lateral plates while facing each other; a first connection member coupled to a driving shaft of an actuator contained in the housing via the first lateral plate, the first connection member having at least one insertion hole of an identical shape as the insertion holes of the first and second lateral plates, the first connection member having a flat plate shape; and an elastic fastener including a hollow socket adapted to be elastically inserted into the insertion hole formed in the first connection member and a fixing pin coupled to a hollow portion of the hollow socket.

### BRIEF DESCRIPTION OF THE DRAWINGS

FIG. 1 shows how to couple a fixing pin to a socket according to a first embodiment of the present invention;

FIG. 2 shows how to couple the fixing pin to the socket according to the first embodiment of the present invention in a direction opposite to that shown in FIG. 1;

FIG. 3 shows the structure of the fixing pin according to the first embodiment of the present invention;

FIG. 4 shows the structure of the socket according to the first embodiment of the present invention;

FIG. 5 shows how to couple a fixing pin to a bidirectional socket according to a second embodiment of the present invention;

FIG. 6 shows how to couple an extensive fixing pin to an extensive socket according to a third embodiment of the present invention;

FIG. 7 shows how to couple an extensive fixing pin to an extensive bidirectional socket according to a fourth embodiment of the present invention;

FIG. 8 shows how to couple an extensive fixing pin to an extensive bidirectional socket according to a fifth embodiment of the present invention;

FIG. 9 shows an example of block coupling using a fixing pin and a socket according to the first embodiment of the present invention;

FIG. 10 shows an example of multiple block coupling using a number of fixing pins and sockets according to the first embodiment of the present invention;

FIG. 11 shows the multiple block coupling shown in FIG. 10 when completed;

FIG. 12 is a sectional view taken along line A-A of the multiple block coupling shown in FIG. 11;

FIG. 13 shows an example of actuator block coupling using an elastic fastener according to the present invention;

FIGS. 14a and 14b are perspective views of an actuator module according to an embodiment of the present invention;

FIGS. 14c and 14d show an example of coupling the actuator module according to the embodiment to a first connection member;

FIGS. 15a and 15b show an example of coupling the actuator module according to the embodiment to a second connection member;

FIGS. 16a and 16b show an example of coupling the actuator module according to the embodiment to a third connection member;

FIGS. 17a and 17b show an example of coupling the actuator module according to the embodiment to a fourth connection member;

FIGS. 18a and 18b show another example of coupling the actuator module according to the embodiment to a second connection member;

FIGS. 19a and 19b show another example of coupling the actuator module according to the embodiment to a fourth connection member;

FIGS. 20a and 20b show an example of coupling the actuator module according to the embodiment to a fifth connection member;

FIGS. 21a and 21b show other coupling examples using actuator modules according to the embodiment and connection members;

FIGS. 22a and 22b show how to assemble a first-type elastic fastener according to the embodiment;

FIG. 23a shows how to assemble a second-type elastic fastener according to the embodiment;

FIG. 23b shows how to assemble a third-type elastic fastener according to the embodiment;

FIGS. 24a and 24b show the structure of the second connection member according to the embodiment;

FIGS. 25a and 25b show the structure of the third connection member according to the embodiment;

FIGS. 26a and 26b show the structure of the fourth connection member according to the embodiment; and

FIG. 27 shows the structure of the fifth connection member according to the embodiment.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components, and so repetition of the description of the same or similar components will be omitted.

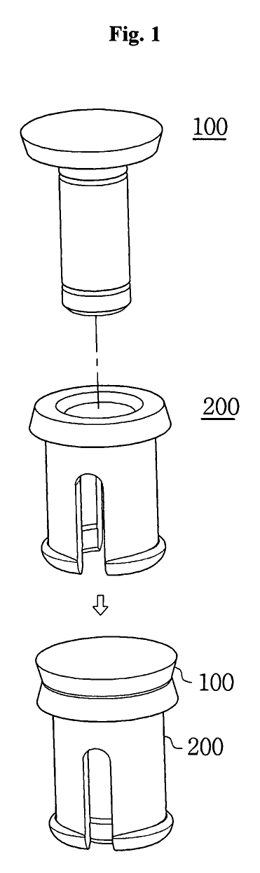

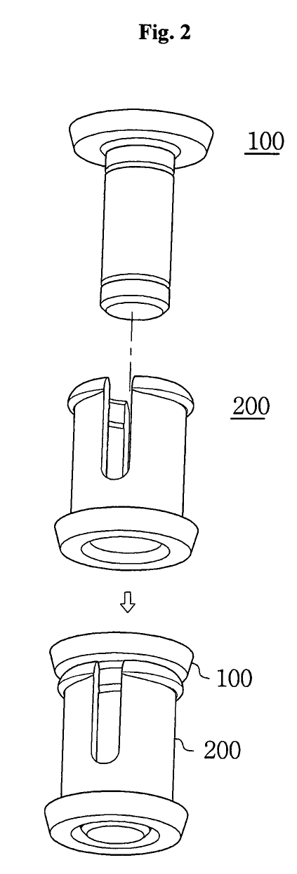

Referring to FIGS. 1 and 2, an elastic fastener is established by coupling the fixing pin 100 to the socket 200, both of which are configured so that the fixing pin 100 can be inserted into the socket 200 from either end.

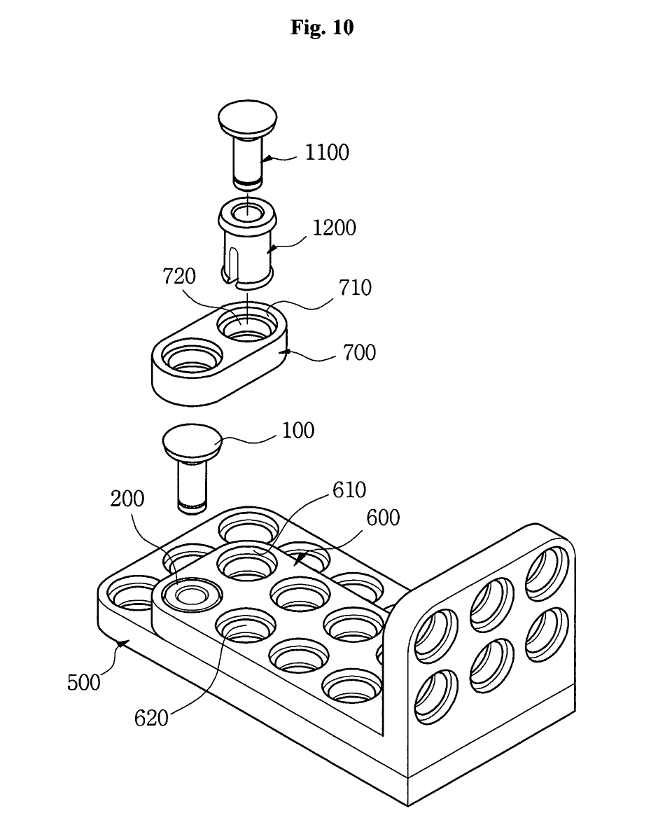

The elastic fastener is adapted to efficiently fasten joint members 500 and 600 having a number of insertion holes which are symmetric about the midplane of the thickness of the member, and which are arrayed in a uniform lattice, as shown in FIG. 9.

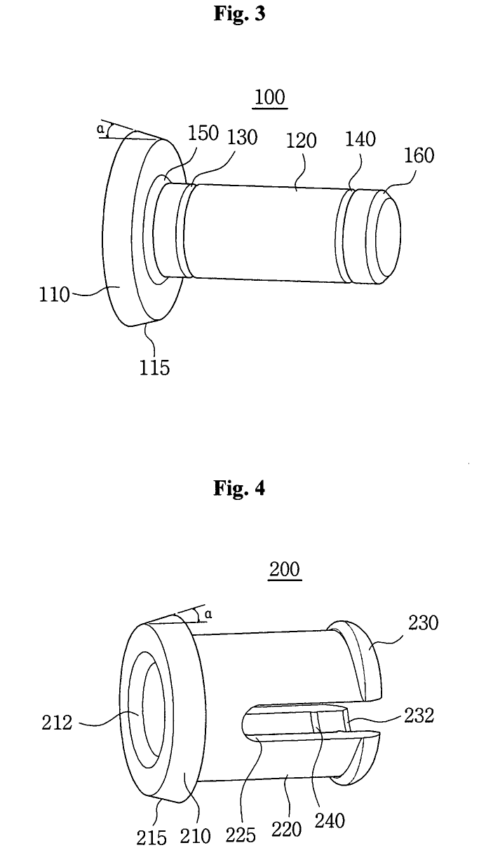

FIG. 3 shows the basic configuration of the fixing pin 100, which includes a head 110 acting as a handle and a shaft 120 extending along the central axis of the head 110.

Although the shaft 120 has a cylindrical overall shape, it may have the shape of a polygonal post depending on the shape of the socket 200, and the shape of the head 110 may also be modified and suited to that of the shaft 120 and the socket 200. The hollow portions of the shaft 120 and the socket 200 preferably have a corresponding geometric structure (e.g. cylindrical, square, etc.), which can be variously selected by those skilled in the art without departing from the scope of the present invention.

The connection portion 150 between the shaft 120 and the head 110, as well as the tip 160 of the shaft 120 are preferably chamfered so that they are efficiently coupled to and forced against the socket 200.

The shaft 120 has a latching groove, and preferably two latching grooves 130 and 140, arranged at a predetermined interval, so that the shaft 120 can be firmly coupled to the socket 200.

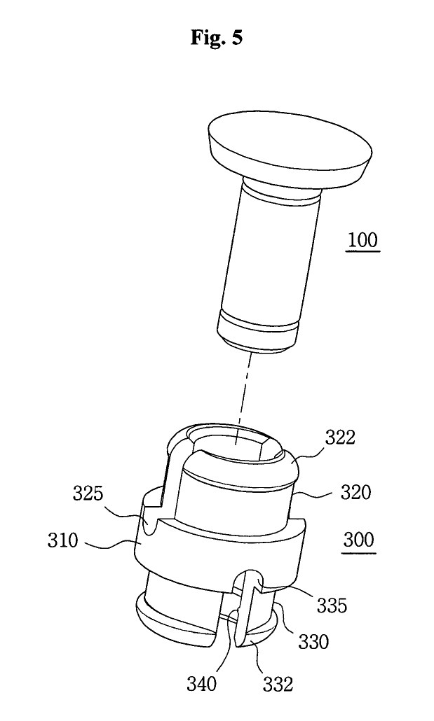

FIG. 4 shows the basic configuration of the socket 200, which includes a hollow tube 220 having a length corresponding to the depth of the insertion holes in the joint members (refer to FIG. 9), an integral latching ledge 210 formed on one end of the hollow tube 220, and a split latching ledge 230 formed on the other end. The hollow tube 220 has at least one, and preferably at least two flexibility enhancing slots 225 extending in the axial direction from a predetermined location on the hollow tube 220 to the end containing the split latching ledge 230 so that one end of the hollow tube 220 and the split latching ledge 230 are split into at least two pieces (fingers).

It will be assumed that the socket 200 is to be coupled to the insertion holes 620 and 520 (FIG. 9) of joint members 600 and 500 that have an inner diameter and a depth corresponding to the outer diameter and the length of the hollow tube 220 of the socket 200, respectively. When the split latching ledge 230 formed on one end of the hollow tube 220 passes through the insertion hole 620 (FIG. 9) of the joint member 600, the hollow tube 220 and the split latching ledge 230, which are split into at least two pieces by the flexibility enhancing slots 225 formed on the hollow tube 220, shrink toward the central axis of the hollow tube 220 and are smoothly inserted into the insertion hole 620 of the joint member. After the hollow tube 220 is fully inserted, the fingers of the hollow tube 200 flexibility enhancingspread out again due to the elastic restoration force. Then, the split and integral latching ledges 230 and 210 formed on both ends of the hollow tube 200 engage with seating portions 510 and 610 formed on both ends of the insertion holes of the joint members 500 and 60). As a result, the socket is firmly coupled to the joint members 500 and 600.

To this end, the socket 200 must be made of a material having enough elasticity to guarantee the above-mentioned elastic coupling. Although no elasticity-related requirements are imposed on the fixing pin 100, it is preferably made of the same material as the socket 200, when considering the manufacturing process, etc. The length of the flexibility enhancing slots 225 must be determined based on the overall length of the socket 200 and the elasticity of the material.

Then, the fixing pin 100 is inserted into the hollow portion of the socket 200 to reinforce the coupling between the insertion holes (not shown) of the joint materials and the socket 200 and to prevent their unwanted separation after the coupling.

The inner diameters of the split and integral latching ledges 230 and 210 of the socket 200 are preferably provided with chamfers 232 and 212, which correspond to the chamfers on the connection portion 150 and the tip 160 of the fixing pin 100, respectively, so that the fixing pin 100 and the socket 200 are forced against and coupled to each other.

The hollow tube 220 has at least one latching ridge 240 formed on its inner surface to engage with the latching grooves 130 and 140 of the fixing pin 100. Considering that the fixing pin 100 is manually inserted into and fixed to the socket 200, only a single latching ridge 240 is preferably formed on the inner surface near the split latching ledge 230.

The lateral portion 115 of the head 110 of the fixing pin 100 and the lateral portion 215 of the integral latching ledge 210 of the socket 200 are preferably slanted at an angle α, considering the shape of the joint members near the insertion holes and the function as a handle, as will be described later in more detail.

Besides the basic configuration, many variations on the shape and size of the fixing pin and socket are possible, which will be described in part hereafter.

Although the split latching ledge 230 formed on the fingered end of the socket 200 flexibility enhancing is indispensable, the latching ledge 210 formed on the opposite end of the socket 200 does not need to have one-piece construction. This means that the latching ledge 210 may also be split into a number of pieces as long as it incorporates the functions required by the present invention.

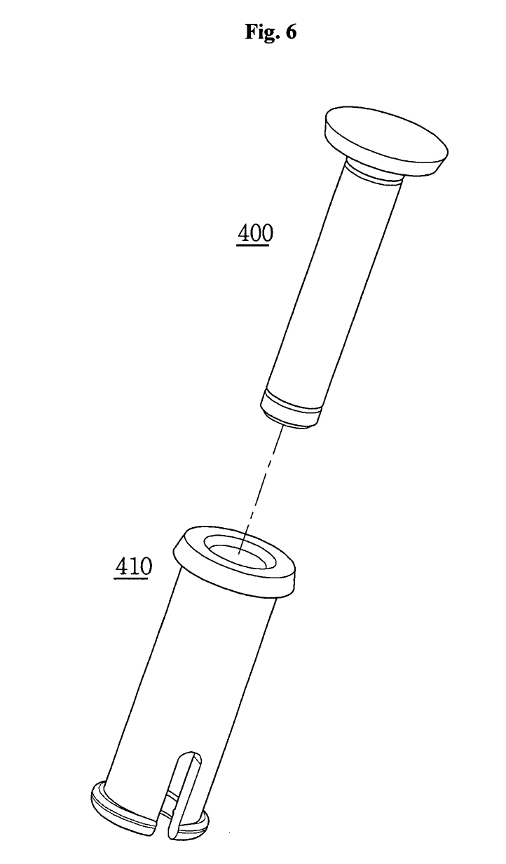

Referring to FIG. 5, the bidirectional socket 300 includes first and second hollow tube portions 320 and 330, split latching ledges 322 and 332 formed on opposite ends of the first and second hollow tube portions 320 and 330 in the same shape so that the bidirectional socket 300 can be simultaneously inserted into the insertion holes (not shown) of two facing joint members, a single integral latching ledge 310 formed around the outer circumference of the central portion of the first and second hollow tube portions 320 and 330, and flexibility enhancing slots 325 and 335 formed on the first and second hollow tube portions 320 and 330, respectively.

Each of the first and second hollow tube portions 320 and 330 has at least one, and preferably two flexibility enhancing slots. The length of the flexibility enhancing slots 325 and 335 must be determined based on the entire length of the bidirectional socket 300 and the elasticity of the material. The offset between the flexibility enhancing slots 325 and 335 is determined in such a manner that the first flexibility enhancing slots 325 formed on the first hollow tube portion 320 are not aligned with the second flexibility enhancing slots 335 formed on the second hollow tube portion 330, preferably in such a manner that the first flexibility enhancing slots 325 are positioned to evenly divide the angular interval between the second flexibility enhancing slots 335.

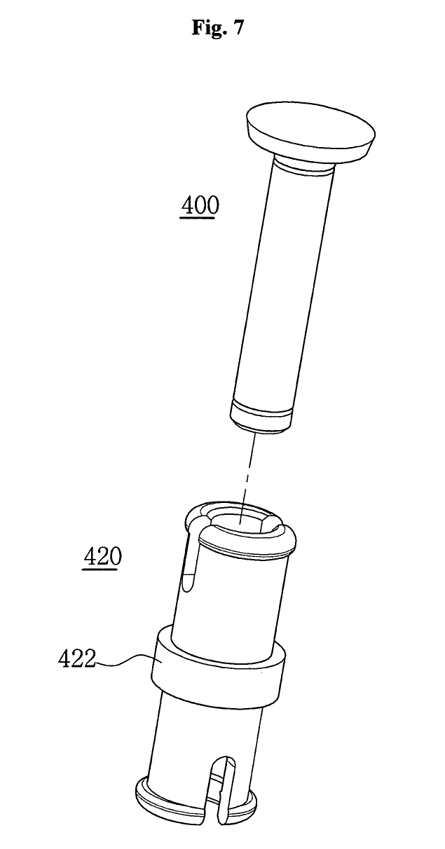

As shown in FIG. 6, the extended fixing pin 400 and the extended socket 410 characteristically have an axial length larger than that of the fixing pin 100 and the socket 200 of the basic type so that they can be used to simultaneously fasten at least two stacked joint members or joint members having deeper insertion holes (not shown). Although the extended fixing pin 400 and the extended socket 410 may have any length, they preferably have a standardized length, e.g. 1.5 times, 2 times, or 3 times the length of the fixing pin 100 and the socket 200 of the basic type, respectively, so that they can be repeatedly coupled to joint members corresponding to blocks following the same standard.

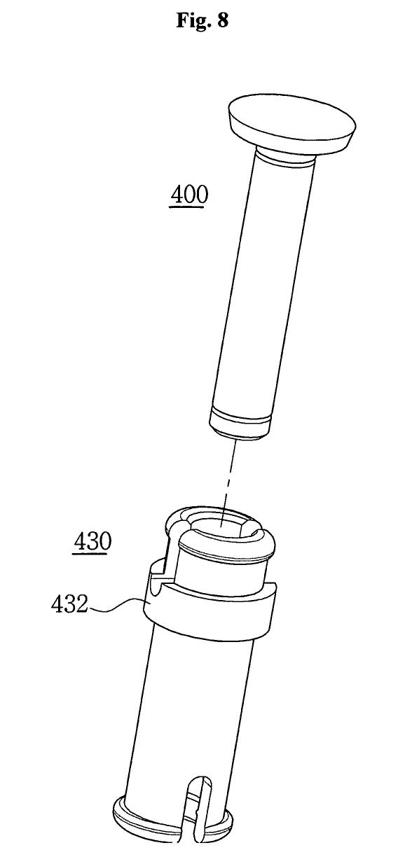

Referring to FIG. 7, the extended bidirectional socket 420 has hollow tube portions (which correspond to the hollow tube portions 320 and 330 of the bidirectional socket 300 shown in FIG. 5) extending the same length in opposite directions from the central portion while being symmetric about the integral latching ledge 422 formed on the central portion.

Although the extended socket 420 may have any length, it preferably has a standardized length, e.g. 1.5 times, 2 times, or 3 times the length of the socket 200 of the basic type so that it can be repeatedly coupled to joint members corresponding to blocks following the same standard.

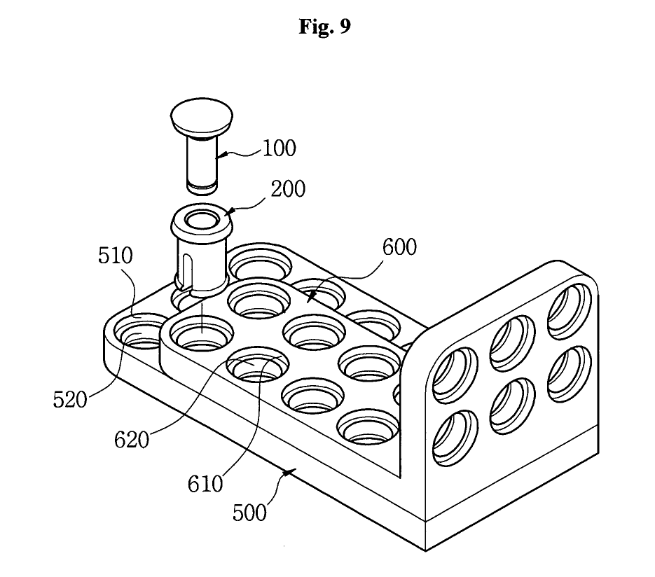

FIG. 8 shows the extended bidirectional socket 430 of the second type having hollow tube portions (which correspond to the hollow tube portions 320 and 330 of the bidirectional socket 300 shown in FIG. 5), only one of which has an extended length compared to the bidirectional socket 300, and the integral latching ledge 432 is not located exactly in the central portion. This means that the two hollow tube portions have different lengths.

Although the ratio of the length of the two hollow tube portions of the extended bidirectional socket 430 of the second type may be determined in any manner, the ratio is preferably standardized, e.g. it corresponds to 2 times, 3 times, or 4 times the entire length of the socket 200 of the basic type so that they can be repeatedly coupled to joint members corresponding to blocks following the same standard.

As seen in FIG. 9, the first and second joint members 500 and 600 correspond to blocks having a standardized thickness, and they have a number of insertion holes 520 and 620 formed thereon so that they can be fastened to each other by the fixing pin 100 and the socket 200.

Respective joint members 500 and 600 have seating portions 510 and 610 formed by counterboring both ends of their insertion holes 520 and 620 to a predetermined depth so that the latching ledges 210 and 230 of the socket 200 can be seated thereon.

The basic socket 200 has a length corresponding to the combined height of the two stacked joint members 500 and 600 so that the socket 200 extends through both insertion holes 520 and 620 of the joint members 500 and 600. The latching ledges 210 and 230 on both ends of the socket 200 are seated on the seating portions 510 and 610 formed on the exposed surfaces of the joint members 500 and 600. After the elastic coupling, the fixing pin 100 is inserted into and fixed to the hollow portion of the socket 200. As a result, the joint members 500 and 600 are firmly coupled to each other by the elastic fastener.

It is to be noted that, if at least two layers of joint members 500 and 600 are coupled by a single elastic fastener including a socket 200 and a fixing pin 100, as shown in FIG. 9, the joint members 500 and 600 can rotate about the elastic fastener as the axis of rotation. This is one of the characteristics of the elastic fastener according to the present invention, which guarantees firm coupling by using a socket 200 having a smooth outer surface.

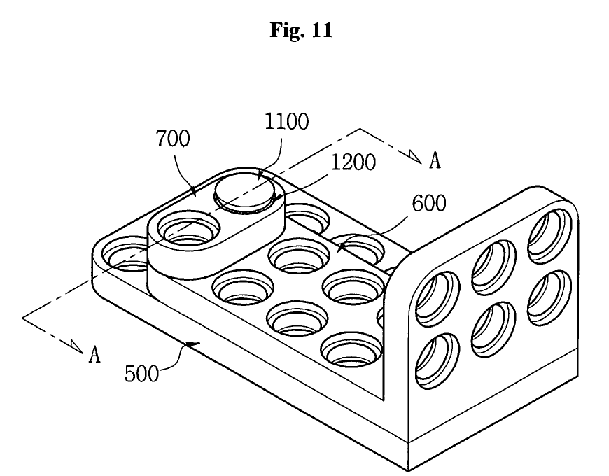

Particularly, FIG. 10 shows an example of continuously coupling multiple blocks by coupling first and second joint members 500 and 600 by a fixing pin 100 and a socket 200 and then coupling second and third joint members 600 and 700.

The same manner of coupling blocks shown in FIG. 9 is repeated for multiple blocks, and there is substantially no limit regarding how many times the multiple block coupling can be repeated.

However, it is to be noted that the depth of the counterbored seating portions 510, 610, and 710 formed on the joint members 500, 600, and 700 corresponds to the height h of the latching ledges of the socket 200 so that, when the socket 200 alone is inserted into the first and second joint members 500 and 600, the socket 200 does not protrude from the surface of the second joint member 600. This means that the socket 200 must have a length determined in such a manner that the multiple, continuous block coupling is not interfered with.

If conventional bolts and nuts were used to fasten the first and second joint members 500 and 600, they would have to be inserted into the insertion holes 520 and 620 from opposite sides of the joint members and seated on the seating portions 510 and 610.

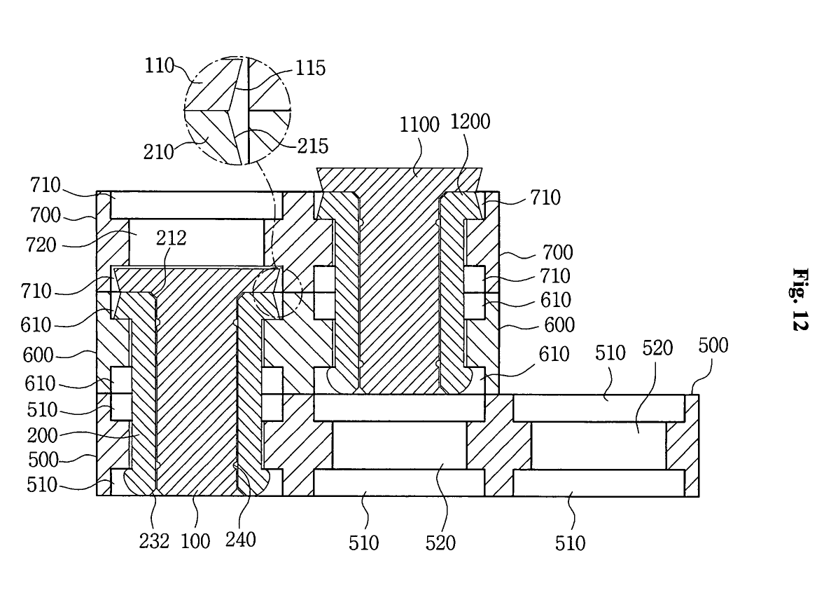

This means that, if the first and second joint members 500 and 600 have already been coupled to each other as shown in FIGS. 10 and 11, bolts and nuts cannot be used to couple the second and third joint members 600 and 700 to each other, because either the bolt or the nut must be inserted into the joint members from the opposite side, which is now inaccessible due to the presence of member 500.

In contrast, the fixing pins 100 and the sockets 200 according to the embodiment of the present invention can be continuously inserted into the joint members from the same side, so that at least two joint members can be coupled to each other when only one surface is exposed.

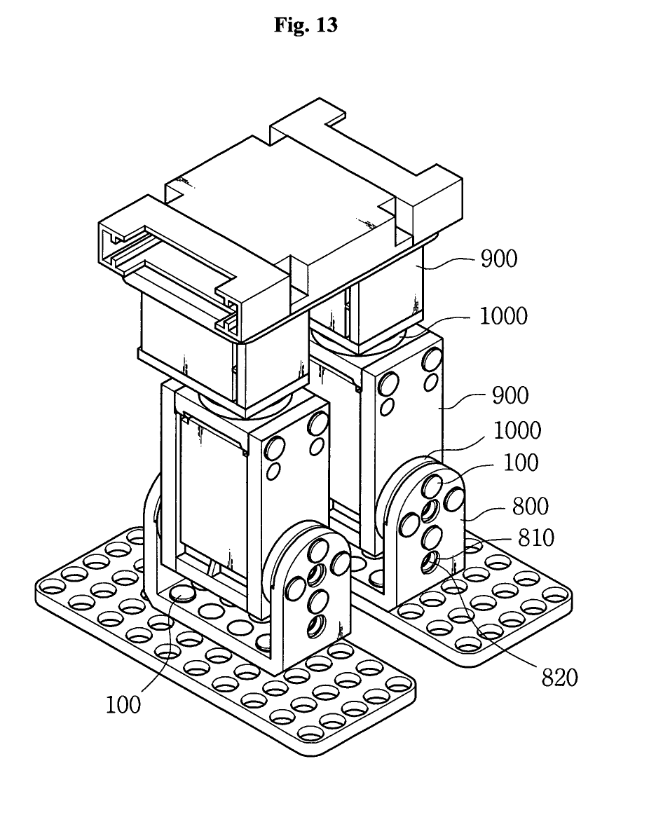

FIG. 12 shows the structural characteristics of the elastic fastener according to the present invention, which can fasten triply stacked joint members 500, 600, and 700 to one another when only one surface of each pair of members is exposed.

When the first and second joint members 500 and 600 are coupled to each other by the first fixing pin 100 and the first socket 200, the two latching ledges on the upper and lower ends of the first socket 200 are elastically coupled to the lower seating portion 510 of the first joint member 500 and to the upper seating portion 610 of the second joint member 600, respectively, so that the upper end of the first socket 200 is flush with the upper surface of the second joint member 600. The head 110 of the first fixing pin 100 protrudes from the upper surface of the second joint member 600 and is received into the lower seating portion 710 of the third joint member 700. As such, the head of the fixing pin has a height, h, corresponding to the depth of the seating portions of the joint members.

The coupling between the second and third joint members 600 and 700 using the second fixing pin 1100 and the second socket 1200 clearly shows the characteristics of the fixing pin, the head of which protrudes. The structure of the fixing pins 100 and 1100, the heads of which protrude when coupled to the sockets 200 and 1200, is beneficial to the characteristics of the elastic fastener according to the present invention, which can be assembled and disassembled by hand without a separate tool.

The lateral portion 115 of the head 110 of the fixing pin 100 and the lateral portion 215 of the integral latching ledge 210 of the socket 200 are symmetrically slanted at a predetermined angle α so that they are not press-fit into the seating portions 610 and 710 of the joint members 600 and 700, and so that they can be used as handles. The lateral portion of the split latching ledge 230 of the socket 200 is preferably rounded or chamfered so that it can be smoothly inserted into the insertion hole.

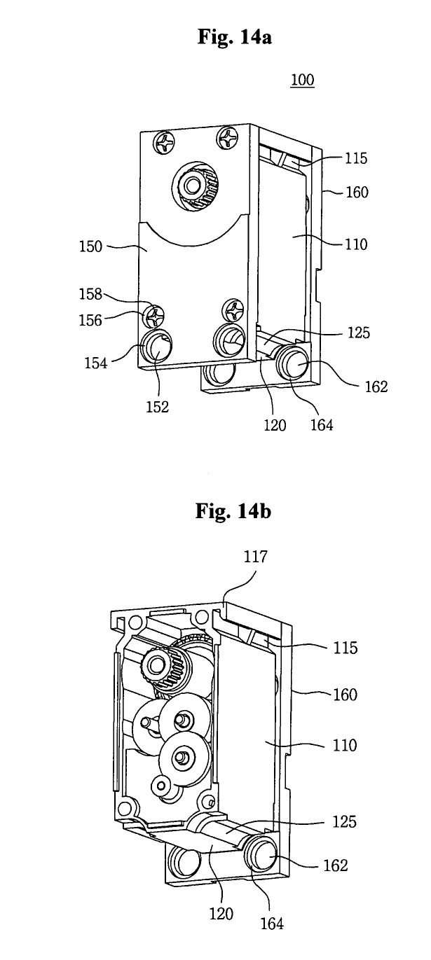

Partially, FIG. 13 shows an articulated robot including various types of joint members provided with a frame having at least one insertion hole 810 formed thereon, and a number of elastic fasteners for coupling the joint members to one another. For example, actuator modules 900, rotation plates 1000, U-shaped support tables 800, etc. are illustrated as joint members having the above-mentioned characteristics according to the embodiment of the present invention.

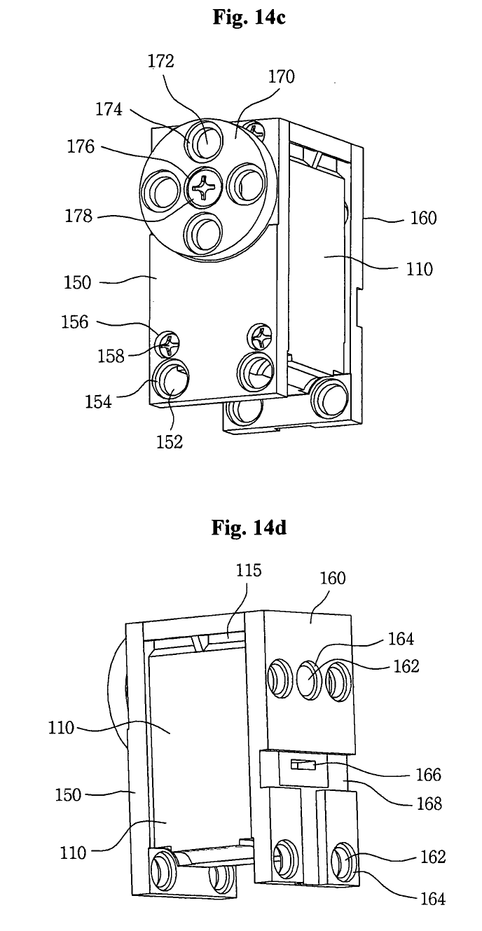

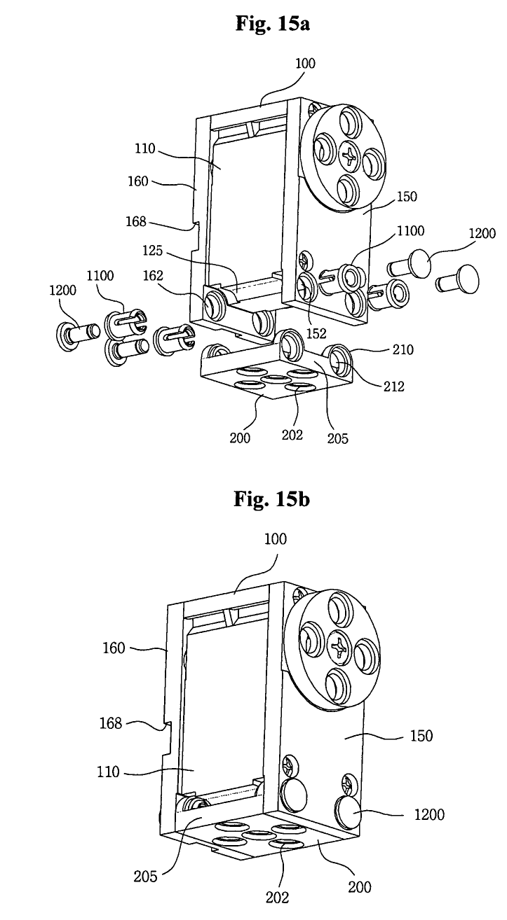

An actuator module according to the present invention, which uses the above-mentioned elastic fastener, will now be described with reference to FIGS. 14-27.

FIGS. 14a and 14b show that the actuator module includes an integral housing 100 containing an actuator, which includes a motor, a gear unit, a sensor unit, etc., and first and second lateral plates 150 and 160 for covering both open surfaces of the housing 100.

The first lateral plate 150 has a coupling hole 156 formed thereon so that the first lateral plate 150 is coupled to the housing 100 by inserting a conventional coupling means 158 (e.g., a bolt) into the housing 100 via the coupling hole 156.

The second lateral plate 160 has a similar coupling hole (not shown) formed thereon so that the second lateral plate 160 is coupled to the housing 100 by a separate coupling means (not shown) or by the coupling means 158, which is inserted from the first lateral plate 150 to extend through the housing 100. Alternatively, the second plate 160 and the housing 100 may be molded as an integral unit.

The first and second lateral plates 150 and 160 have at least one insertion hole 152 and 162 so that the elastic fastener according to the above-mentioned embodiment of the present invention can be inserted. The insertion holes 152 and 162 are counterbored to form seating portions 154 and 164 for the head of the elastic fastener so that, when the elastic fastener is coupled to the insertion holes 152 and 162, the head of the elastic fastener does not protrude.

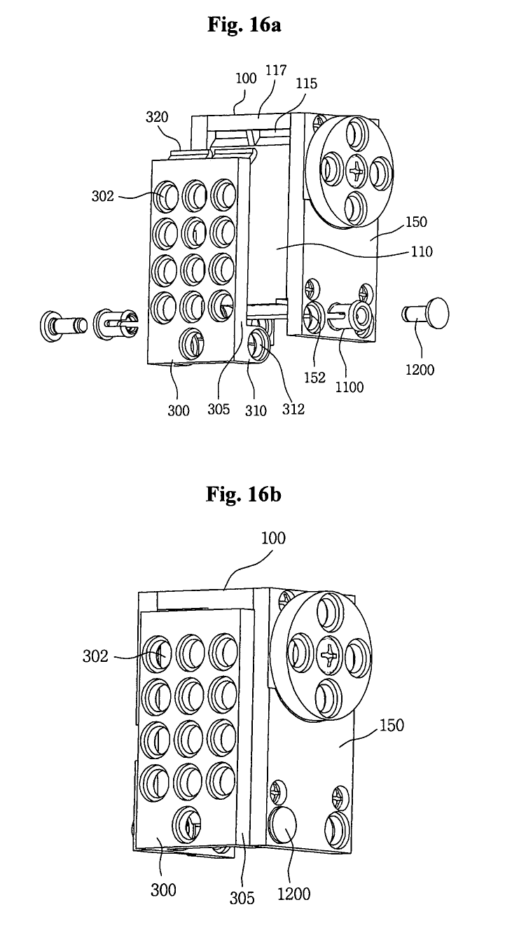

The housing 100 has a latching groove 115 and a latching ledge 117 formed on a lateral surface 110 to be coupled to latching ridges (not shown) of various connection members (i.e., joint members). A guide groove 125 is formed between the lateral surface 110 of the housing 100 and its lower surface 120 so as to guide the elastic fastener inserted via the insertion hole 162 when coupled to the connection members. The other lateral surface 110 (refer to FIG. 15a) of the housing 100, which is not shown in FIGS. 14a and 14b, has the same structure.

The width of each lateral plate 150 and 160 of the housing 100 is identical to that of the lateral surface 110 of the housing 100 so that the actuator module has a standardized structure, i.e. it can be modularly coupled to various connection members having the same width, diameter, or length of sides as the width of the actuator.

As shown in FIGS. 14c and 14d, the first connection member 170 is a rotatable body driven by an actuator, and is coupled to the first lateral plate 150 and to the housing 100 by inserting a conventional coupling means 178 (e.g., a bolt) into the hollow portion of a motor shaft inside the housing 100 via a coupling hole 176.

The first connection member 170 has at least one, and preferably four, insertion holes 172 arranged at an equiangular interval. Each insertion hole 172 has a seating portion 174 formed thereon so that the head of the elastic fastener can be seated thereon.

The second lateral plate 160 similarly has at least one insertion hole 162 formed thereon, which has a seating portion 164. In addition, the second lateral plate 160 has a wiring opening 166, through which wires extend to the actuator, and a wiring guide groove 168 for guiding the routing of the wires so that they are not exposed to the outside of the actuator module.

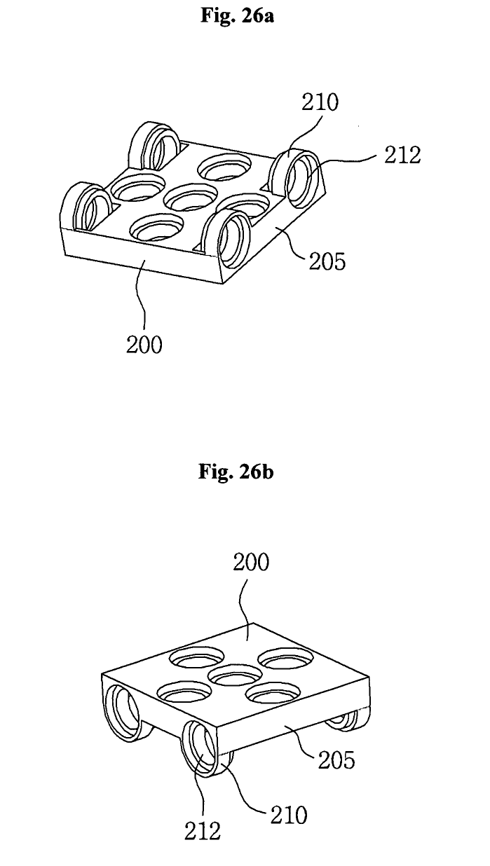

As shown in FIGS. 15a and 15b, the second connection member 200, as shown in FIGS. 26a and 26b, includes a square base frame 205 having at least one insertion hole 202 formed through its thickness, and a fixing portion 210 protruding in a direction perpendicular to each end of the base frame 205 to define an insertion hole 212 perpendicular to the insertion hole 202 of the base frame 205.

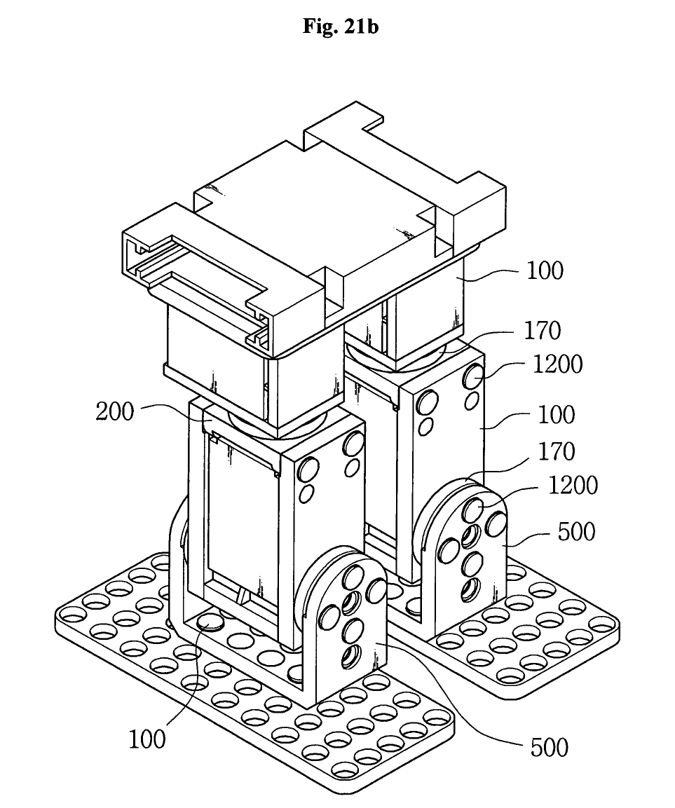

Referring to FIG. 15a, the base frame 205 of the second connection member 200 is attached to the lower surface 120 of the housing 100 so that the insertion holes 212 of the respective fixing portions 210 of the second connection member 200 are aligned with the insertion holes 152 and 162 of respective lateral plates 150 and 160 of the actuator module. Then, basic elastic fasteners 1100 and 1200 as shown in FIGS. 22a and 22b are inserted through the insertion holes 212, 152, and 162 for fixation. The structure of the elastic fasteners 1100 and 1200 will be described later.

Each side of the base frame 205 of the second connection member 200 has a size corresponding to the width of the lateral surface 110 of the housing 100 so that, when the second connection member 200 and the housing 100 are coupled to each other, the outer surface of the fixing portions 210 of the second connection member 200 abuts the inner surface of respective lateral plates 150 and 160.

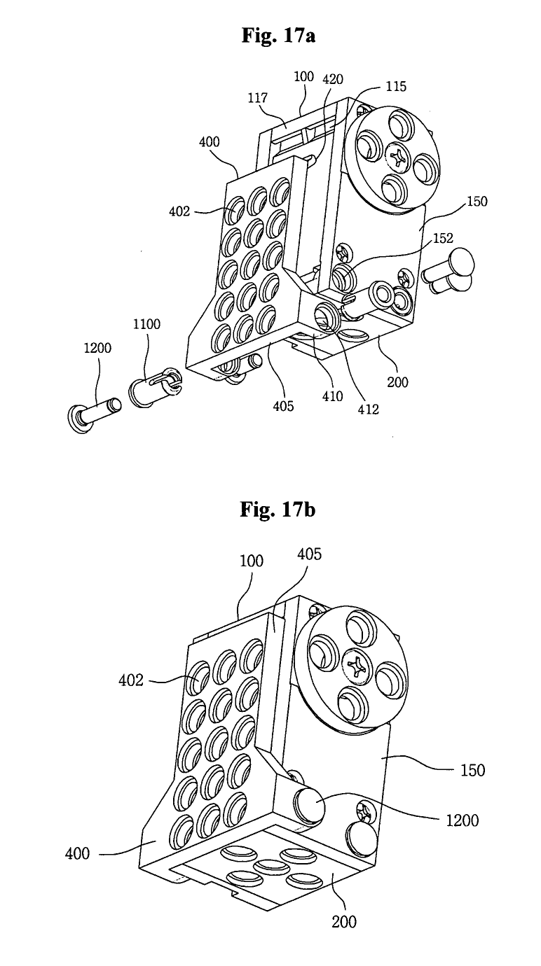

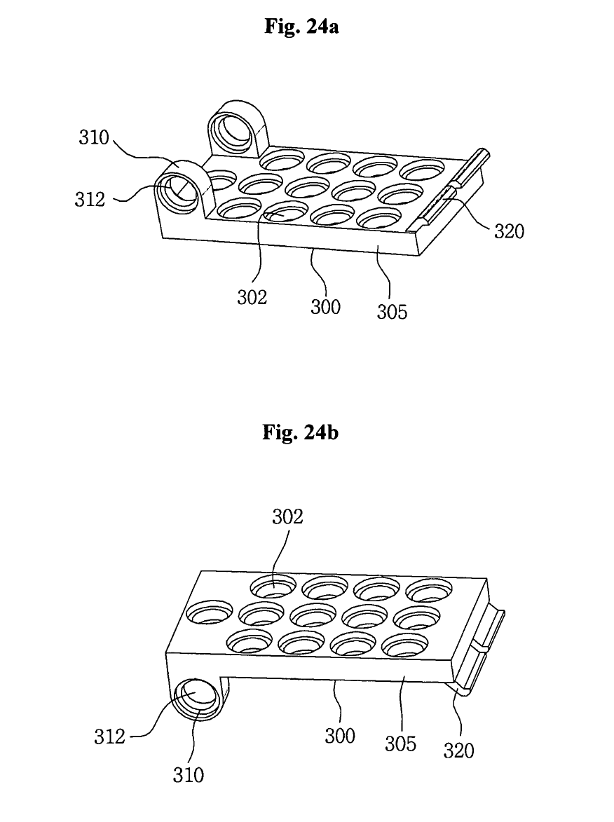

Referring to FIGS. 16a and 16b, the third connection member 300, as shown in FIGS. 24a and 24b, includes a rectangular base frame 305, at least one fixing portion 310 protruding in a direction perpendicular to one end of the base frame 305 to define an insertion hole 312 perpendicular to the insertion holes 302 of the base frame 305, and a latching tab 320 protruding at an angle from the other end of the base frame 305 in the outward direction to be coupled to the latching groove 115 and the latching ledge 117, which are formed on the lateral surface 110 of the actuator module housing 100.

Referring to FIG. 16a, the latching tab 320 of the third connection member 300 is inserted into the latching groove 115 formed on the lateral surface 110 of the actuator module housing 100 to be supported by the latching ledge 117. Then, the basic style elastic fasteners 1100 and 1200 are inserted through the insertion holes 152 of the respective lateral plates 150 and 160 of the actuator module, as well as the insertion holes 312 of the fixing portions 310 of the third connection member 300 for fixation.

The long axis of the base frame 305 of the third connection member 300 has a length corresponding to the distance between the end of the latching ledge 117 of the lateral surface 110 of the housing 100 and the opposite end of the lateral plates 150 and 160, and the short axis has a length corresponding to the width of the lateral surface 110 of the housing 100 so that, when the third connection member 300 and the housing 100 are coupled to each other, the outer surface of the respective fixing portions 310 of the third connection member 300 abuts the inner surface of the respective lateral plates 150 and 160.

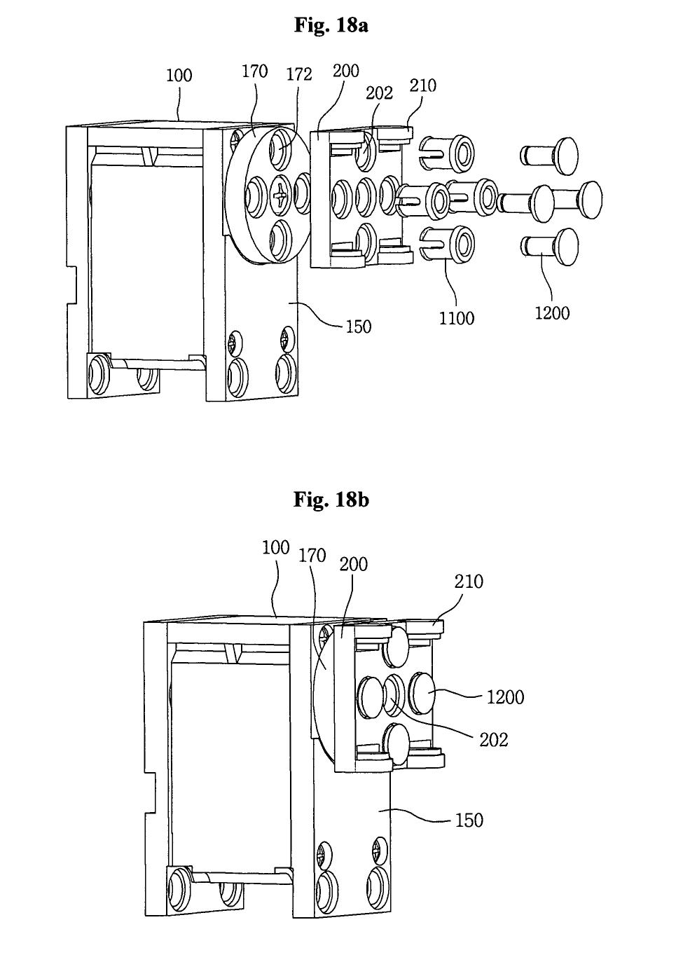

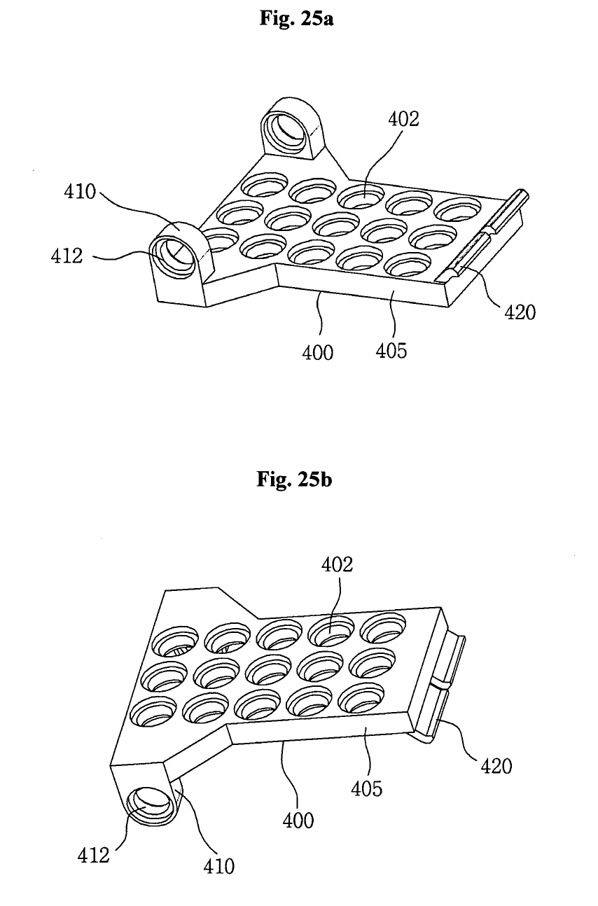

Referring to FIGS. 17a and 17b, the fourth connection member 400, as shown in FIGS. 25a and 25b, includes a base frame 405 having the general shape of a rectangle with ears flared out on each side of one short end, at least one fixing portion 410 protruding in a direction perpendicular to each ear of the base frame 405 to define an insertion hole 412 perpendicular to the insertion holes 402 of the base frame 405, and a latching tab 420 protruding at an angle from the other end of the base frame 405 in the outward direction to be coupled to the latching groove 115 and the latching ledge 117, which are formed on the lateral surface 110 of the actuator module housing 100.

Referring to FIG. 17a, the latching tab 420 of the fourth connection member 400 is inserted into the latching groove 115 formed on the lateral surface 110 of the actuator module housing 100 to be supported by the latching ledge 117. Then, the basic style elastic fasteners 1100 and 1200 are inserted through the insertion holes 152 of respective lateral plates 150 and 160 of the actuator module, as well as the insertion holes 412 of the fixing portions 410 of the fourth connection member 400 for fixation.

The long axis of the base frame 405 of the fourth connection member 400 has a length corresponding to the distance between the end of the latching ledge 117 of the lateral surface 110 of the housing 100 and the opposite end of the lateral plates 150 and 160, and the short axis has a maximum length (measured across the ears) corresponding to the distance between the outer surfaces of the two lateral plates 150 and 160 of the housing 100 so that, when the fourth connection member 400 and the housing 100 are coupled to each other, the fixing portions 410 of the fourth connection member 400 fit around the outside of the two lateral plates 150 and 160 of the housing 100 with the inner surface of the fixing portions 410 abutting the outer surface of respective lateral plates 150 and 160.

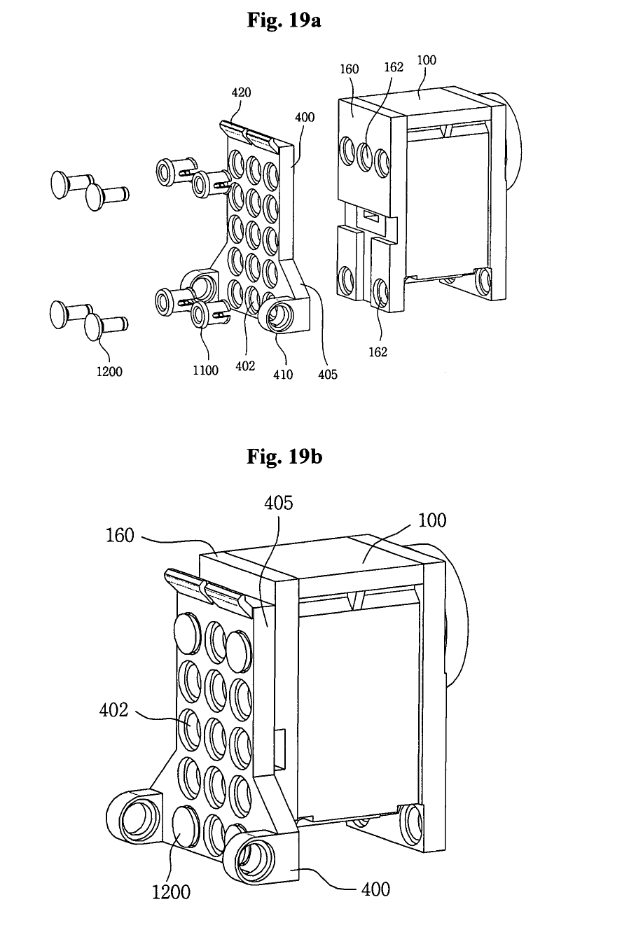

As shown in FIGS. 18a and 18b, an additional second connection member 200 is coupled to the actuator module housing 100, to which a first connection member 170 has already been coupled.

In order to enable such coupling, the insertion holes 172 and 202 of the first and second connection members 170 and 200 must be aligned with each other, and respective connection members 170 and 200 preferably have fourth insertion holes 172 and 202 formed at an equiangular interval as shown in the drawings.

The first connection member 170 preferably has a diameter corresponding to the length of each side of the second connection member 200.

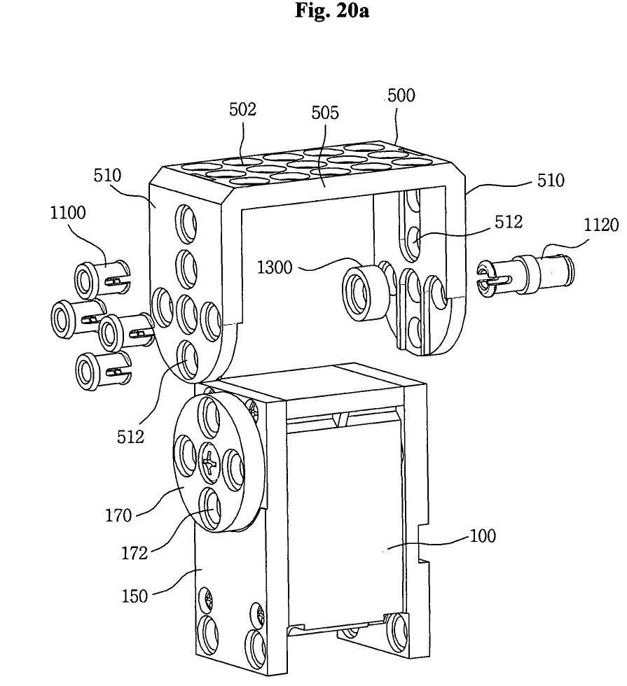

Referring to FIG. 19a, a surface of the base frame 405 of the fourth connection member 400, on which no latching tab 420 is formed, is attached to the second lateral plate 160 of the actuator module housing 100, and basic style elastic fasteners 1100 and 1200 are inserted through the insertion holes 162 of the second lateral plate 160 of the actuator module, as well as the insertion holes 402 of the base frame 405 of the fourth connection member 400, for fixation.

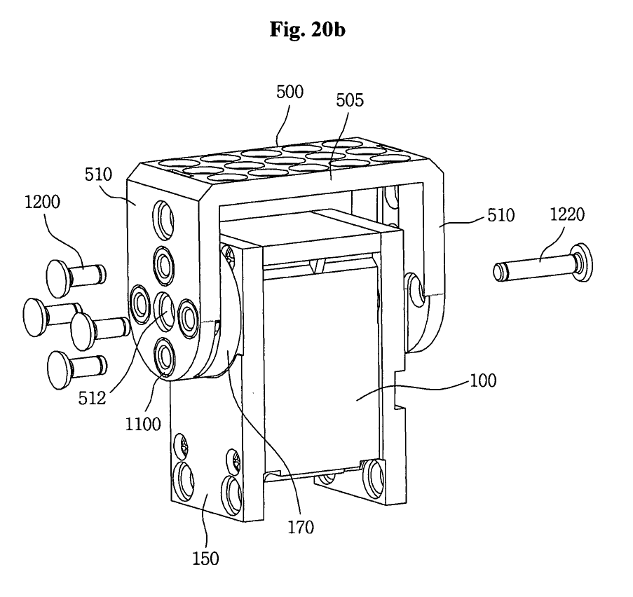

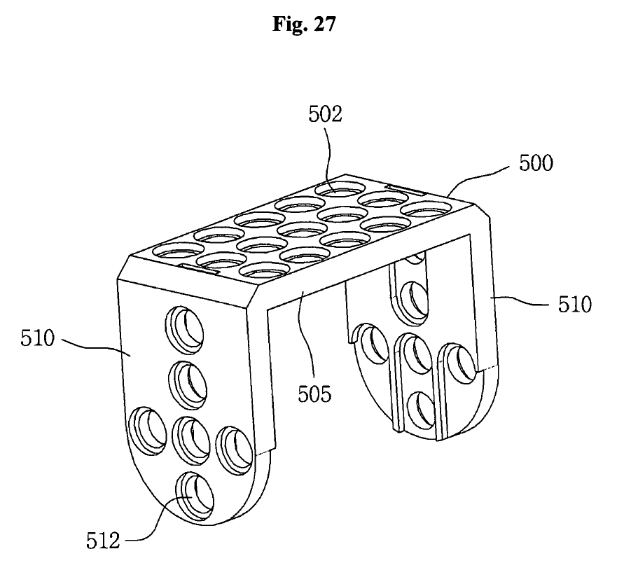

Referring to FIGS. 20a and 20b, the fifth connection member 500, as shown in FIG. 27, includes a rectangular base frame 505 and side frames 510 extending from both short ends of the base frame 505 at a right angle, i.e., protruding in a direction perpendicular to the base frame 505. Therefore, the insertion holes 502 of the base frame 505 are perpendicular to the insertion holes 512 of the side frames 510.

Referring to FIG. 20a, the fifth connection member 500 is coupled to the actuator module in the following manner: the actuator module housing 100 is inserted between the side frames 510 of the fifth connection member 500 together with a spacer 1300, and basic style elastic fasteners 1100 and 1200 are inserted through the insertion holes 172 of the first connection member 170, which has already been coupled to the housing 100, and the insertion holes 512 of the side frames 510 of the fifth connection member 500. In addition, bidirectional elastic fasteners 1120 and 1220 extend through the insertion holes (not shown) formed on the second lateral plate 160 and the insertion holes 512 of the side frames 510 for fixation.

The fifth connection member 500 is adapted to transmit a driving force from the actuator contained in the actuator module housing 100 to another component by coupling the side frames 510 to the housing 100, to which the first connection member 170 is coupled as a rotating body, and by coupling the base frame 505 to the other component (not shown) such as another actuator module or another connection member. The long axis of the base frame 505 has a length corresponding to the sum of the distance between the lateral plates 150 and 160 of the housing 100, the width of the first connection member 170 already coupled to the housing 100, and the width of the spacer 1300, and the short axis is standardized to have a length corresponding to the width of the lateral plates 150 and 160 of the actuator module.

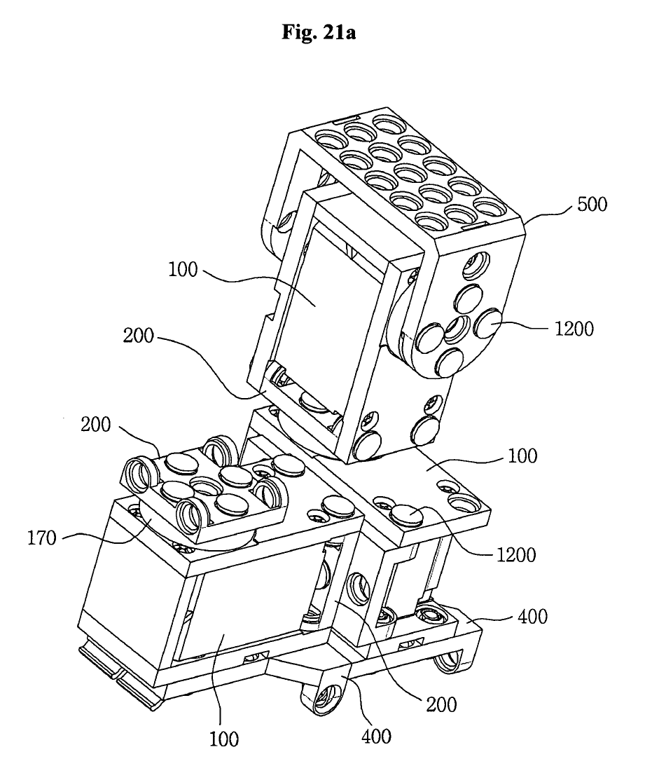

Referring to FIG. 21a, a number of components having at least one insertion hole (e.g., an actuator module 100, connection members including first, second, fourth, and fifth connection members 170, 200, 400, and 500, etc.) are coupled to one another by a number of fastening means (e.g., basic style elastic fasteners 1200) having a structure corresponding to that of the insertion holes, and together they constitute part of a model robot. The connection members are commonly characterized in that they have at least one insertion hole provided with a seating portion for elastic fasteners.

Referring to FIG. 21b, a number of components having at least one insertion hole (e.g., an actuator module 100, first, second, and fifth connection members 170, 200, and 500, other planar blocks, etc.) are coupled to one another by a number of fastening means (e.g., basic style elastic fasteners 100) having a structure corresponding to that of the insertion holes, and together they constitute an operational toy block. The connection members are also commonly characterized in that they have at least one insertion hole provided with a seating portion for elastic fasteners.

Referring to FIG. 22a, a fixing pin 1200 and a socket 1100 are coupled to each other to constitute a basic style elastic fastener, and, referring to FIG. 22b, the fixing pin 1200 is coupled to the socket 1100 in the opposite direction to constitute a basic style elastic fastener.

The basic style elastic fastener is characterized in that the fixing pin 1200 and the socket 1100 can be coupled to each other in either direction to constitute the basic style elastic fastener, and that the structure of the basic style elastic fastener makes it possible to efficiently couple the basic style elastic fastener to various types of connection members including a frame having at least one insertion hole that is symmetric about the midplane of the thickness of the frame.

The basic style elastic fastener will be described in more detail with reference to FIGS. 22a and 22b. The fixing pin 1200 includes a head 1210 acting as a handle, and a shaft 1205 extending along the central axis of the head 1210.

The connection portion 1220 between the shaft 1205 and the head 1210, as well as the tip 1230 of the shaft 1205 are preferably chamfered so that they can be efficiently coupled to and forced against the socket 1100. In addition, the shaft 1205 has two latching grooves 1202 and 1204 formed on its surface and arranged at a predetermined interval, so that the shaft 1205 can be firmly coupled to the socket 1100.

The socket 1100 is of the basic type, and includes a hollow tube 1105 having a length corresponding to the depth of insertion holes of a connection member, an integral latching ledge 1110 formed on one end of the hollow tube 1105, and a split latching ledge 1120 formed on the other end. The hollow tube 1105 has two flexibility enhancing slots 1130 extending from a predetermined location on the hollow tube 1105 to the split latching ledge 1120 so that a portion of the hollow tube 1105 and the split latching ledge 1120 are split into at least two pieces (fingers).

It will be assumed that the socket 1100 is to be coupled to an insertion hole of a connection member that has an inner diameter and a depth corresponding to the outer diameter and the length of the hollow tube 1105 of the socket 1100, respectively. When the split latching ledge 1120 formed on the split end of the hollow tube 1105 passes through the insertion hole of the connection member, the fingers formed by the flexibility enhancing slots 1130 on the hollow tube 1105, compress toward the central axis of the hollow tube 1105 and are smoothly inserted into the insertion hole of the connection member. After the hollow tube 1105 is completely coupled to the insertion hole of the connection member, the flexibility enhancing fingers spread out again due to the restoring force of the elastic material. Then, the integral latching ledge 1110 formed on the non-split end of the hollow tube 1105 engages with the insertion hole of the connection member. As a result, the split and integral latching ledges 1120 and 1110 each engage with one end of the insertion hole of the connection member, so that the socket 1110 is firmly and elastically coupled to the insertion hole (not shown) of the connection member.

To this end, the socket 1100 must be made of a material having enough elasticity to guarantee the above-mentioned elastic coupling. Although no elasticity-related requirements are imposed on the fixing pin 1200, it is preferably made of the same material as the socket 1100, when considering the manufacturing process, etc. The length of the flexibility enhancing slots 1130 must be determined based on the overall length of the socket 1100 and the elasticity of the material.

Then, the fixing pin 1200 is inserted into the hollow portion of the socket 1100 to reinforce the coupling between the insertion hole of the connection member and the socket 1100 and to prevent their unintentional separation after the coupling.

The inner diameters of the split and integral latching ledges 1120 and 1110 of the socket 1100 are preferably provided with chamfers 1122 and 1112, which correspond to the chamfers on the connection portion 1220 and the tip 1230 of the fixing pin 1200, respectively, so that the fixing pin 1200 and the socket 1100 are forced against and coupled to each other.

The hollow tube 1105 has at least one latching ridge 1102 formed on its inner diameter to engage with the latching grooves 1202 and 1204 of the fixing pin 1200.

The lateral portion 1215 of the head 1210 of the fixing pin 1200 and the lateral portion 1115 of the integral latching ledge 1110 of the socket 1100 are preferably slanted at corresponding angles, considering the shape of the insertion hole of the connection member having an indented seating portion, the function as a handle, etc.

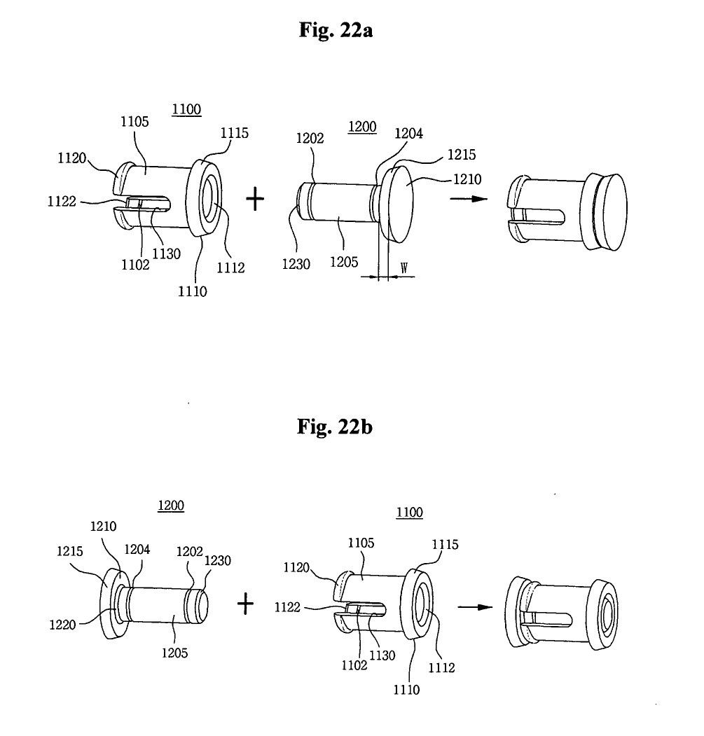

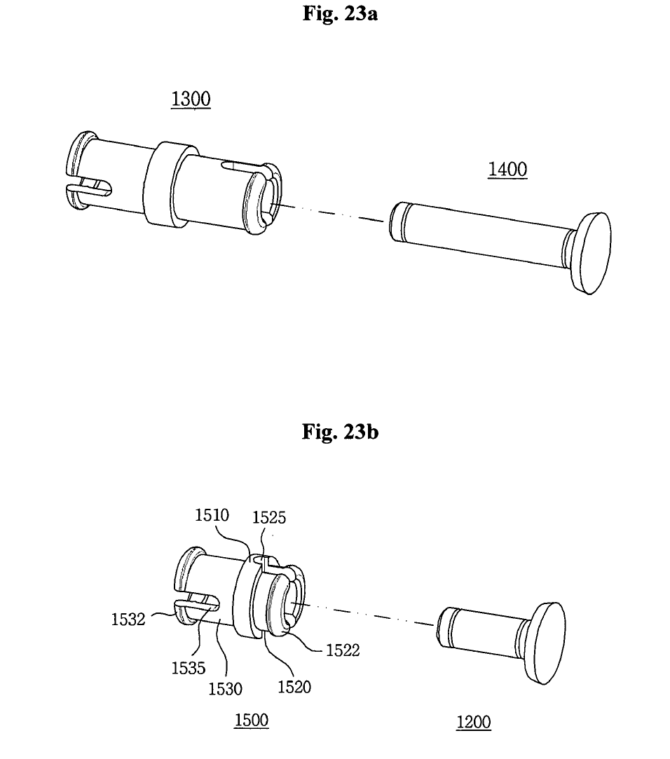

As shown in FIG. 23a the extended bidirectional elastic fastener includes an extended fixing pin 1400 and an extended bidirectional socket 1300. The extended fixing pin 1400 and the extended bidirectional socket 1300 characteristically have an axial length larger than that of the fixing pin 1200 and the socket 1110 of the basic type so that they can be used to simultaneously fasten at least two stacked connection members or connection members having deeper insertion holes. Although the extended fixing pin 1400 and the extended bidirectional socket 1300 may have any length, they preferably have a standardized length, e.g., 2 times, 3 times, or 4 times the length of the fixing pin 1200 and the socket 1100 of the basic type, respectively, so that they can be repeatedly coupled to standardized connection members.

The elastic fastener and the actuator module using the same according to the present invention have the following advantages:

The elastic fastener can be assembled and disassembled easily, even without the use of a separate tool, and can be coupled firmly and repeatedly without causing the fastener itself or joint members to wear down or fracture.

By inserting a hollow socket into the insertion holes of joint members and then inserting a fixing pin into the hollow portion of the socket, the elastic fastener cannot be unintentionally separated from the joint members. In other words, the socket cannot be separated from the joint members as long as the fixing pin remains inserted.

The elastic fastener uses a socket having a smooth outer surface so that joint members are firmly fastened to each other while being able to rotate.

The elastic fastener is adapted to fasten mulutiple joint members.

The elastic fastener is adapted to fasten joint members having a number of insertion holes which are symmetric about the midplane of the thickness of the member, and which are arrayed in a uniform lattice.

The elastic fastener has the above-mentioned characteristics so that it is useful for model robots, toy blocks, etc.

The actuator module according to the present invention is applicable to model robots, operable toy blocks, etc. and is adapted to provide a robot solution having a high degree of freedom, extendability, and compatibility so that the user can modify and upgrade the robot by himself/herself.

The actuator module has a universal coupling structure, i.e., it is capable of establishing a repeated coupling structure much more efficiently than when conventional coupling means (e.g., bolts and nuts) are used, by forming insertion holes on the actuator module and the connection member in a standardized manner and providing elastic fasteners adapted to be coupled to the insertion holes efficiently.

The actuator module has a universal coupling structure so that, by introducing a new design of each part of the actuator module housing, not only the actuator module and the connection member can be assembled and coupled easily, but also the wiring can be properly handled when components are coupled.

The actuator module can be coupled to a number of connection members using elastic fastening means according to the present invention, which can be assembled and disassembled easily, even without the use of a separate tool, and can be firmly and repeatedly coupled without causing the fasteners or joint members (i.e. connection members) to wear down or fracture.

The actuator module includes hollow sockets inserted into the insertion holes of joint members and fixing pins additionally inserted into the hollow portions of the sockets so that the elastic fasteners will not separate from the joint members (i.e., connection members) unintentionally, guaranteeing stable operation of the robot.

The actuator module can be coupled to a number of connection members using elastic fasteners including sockets having a smooth outer surface so that joint members (i.e. connection members) are firmly fastened to each other while being able to rotate.

The actuator module has an elastic fastener adapted for multiple coupling.

The actuator module and connection member according to the present invention include a frame having a number of insertion holes which are symmetric about the midplane of the thickness of the member, and which are standardized and arrayed in a uniform lattice.

The actuator module and connection module have the above-mentioned characteristics so that they are useful for model robots, operable toy blocks, etc.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An elastic fastener used for rapid assembly or disassembly, the elastic fastener comprising:
a hollow socket adapted to be elastically inserted into insertion holes formed on a joint member, said hollow socket consisting of a hollow tube having a length the same as the depth of an insertion hole on the joint members and at least one flexibility enhancing slot formed longitudinally on the lateral surface of said hollow tube and extending to one end of said hollow tube so that fingers are formed at the end of the hollow tube, and
a fixing pin for coupling to a hollow portion of said hollow socket, said fixing pin consisting of a head and a shaft integrally formed with the head, wherein said fixing pin includes at least one latching groove formed on the shaft, and at least one latching ridge formed on an inner surface of the hollow socket, said latching ridge mating to said latching groove.

2. The elastic fastener as claimed in claim 1, wherein the hollow socket further comprises a split latching ledge formed on the end of the hollow tube that is divided into fingers, and an integral latching ledge formed on the opposite end of the hollow tube.

3. The elastic fastener as claimed in claim 2, wherein the head of the fixing pin and the latching ledges of the socket have slanted lateral portions, and the shaft of the fixing pin has a structure corresponding to the hollow portion of the hollow tube of the socket, and wherein at least two flexibility enhancing slots are formed on the hollow tube.

4. The elastic fastener as claimed in claim 2, wherein the socket and the fixing pin are adapted to be inserted into the insertion holes from the same side when coupled to the joint members.

5. The elastic fastener as claimed in claim 2, wherein the socket and the fixing pin are adapted so that the joint members can rotate about the central axis of the socket and the fixing pin when the socket and the fixing pin are coupled to the joint members.

6. The elastic fastener as claimed in claim 3, wherein the integral and split latching ledges of the socket have chamfers formed on their inner diameters, and a fillet between the head and the shaft of the fixing pin and the tip of the shaft have chamfers corresponding to the chamfers of the integral and split latching ledges, respectively, so that the fixing pin and the socket are forced against and coupled to each other, and wherein the split latching ledge of the socket is rounded.

7. The elastic fastener as claimed in claim 3, wherein the integral and split latching ledges of the socket are adapted to be coupled to counterbored seating portions of the joint members when the socket is coupled to the joint members, the seating portions have a depth corresponding to the height of the integral and split latching ledges of the socket, and the socket is adapted to be flush with the surfaces of the joint members when the socket couples at least two joint members to each other.

8. The elastic fastener as claimed in claim 2, wherein the joint members have a number of insertion holes arrayed in a uniform lattice, the insertion holes being symmetric about the midplane of the thickness of the members.

9. The elastic fastener as claimed in claim 8, wherein the joint members have seating portions formed by counterboring the insertion holes in the frame portion to a predetermined depth.

10. The elastic fastener as claimed in claim 5, wherein the head of the fixing pin is adapted to protrude out of the joint members when the fixing pin is coupled to the socket, which is coupled to the joint members, and wherein the head of the fixing pin has a height corresponding to the depth of the counterbored seating portions of the joint members.

11. An actuator module comprising:
a housing comprising a first lateral plate having at least one insertion hole for inserting an elastic fastener, a second lateral plate positioned to face the first lateral plate and provided with at least one insertion hole of an identical shape as the insertion hole of the first lateral plate, and two lateral surfaces positioned between both ends of the first and second lateral plates while facing each other;
a first connection member coupled to a driving shaft of an actuator contained in the housing via the first lateral plate, the first connection member having at least one insertion hole of an identical shape as the insertion holes of the first and second lateral plates, the first connection member having a flat plate shape; and
an elastic fastener comprising a hollow socket adapted to be elastically inserted into the insertion hole formed on the first connection member and a fixing pin coupled to a hollow portion of the hollow socket.

12. The actuator module as claimed in claim 11, wherein the hollow socket consists of a hollow tube having a length corresponding to the depth of the insertion holes, includes at least two flexibility enhancing slots extending longitudinally from a location on the hollow tube to one end of the hollow socket, the fixing pin includes a head and a shaft extending along a central axis of the head, and wherein the hollow socket and the fixing pin are made of an elastic material.

13. The actuator module as claimed in claim 12, wherein the hollow socket comprises:
a split latching ledge formed on the end of the hollow tube that is split by the flexibility enhancing slots; and
an integral latching ledge formed at a predetermined location on the hollow tube spaced away from the split latching ledge, the integral latching ledge being seated on the seating portions formed by counterboring the insertion holes to a predetermined depth.

14. The actuator module as claimed in claim 13, wherein the depth of the seating portions corresponds to a width of the latching ledge or the split latching ledge of the hollow socket, and, when the hollow socket is coupled to the insertion holes, the latching ledge or the split latching ledge formed on each end of the hollow socket is coupled to the seating portions formed on the insertion holes so that the latching ledge or the split latching ledge of the hollow socket does not protrude out of the insertion holes.

15. The actuator module as claimed in claim 14, wherein the depth of the seating portions corresponds to the height of the head of the fixing pin, and, when the hollow socket coupled to the insertion holes is coupled to the fixing pin, the head of the fixing pin protrudes out of the insertion holes.

16. The actuator module as claimed in claim 15, wherein the actuator module further comprises a second connection member, and the second connection member comprises a square base frame having at least one insertion hole of an identical shape as the insertion holes of the actuator module and a fixing portion protruding perpendicularly to each end of the base frame and having an insertion hole of an identical shape as the insertion hole in the base frame.

17. The actuator module as claimed in claim 16, wherein the actuator module further comprises a third connection member, the third connection member comprising a rectangular base frame having at least one insertion hole of an identical shape as the insertion holes of the actuator module, a fixing portion protruding from a short edge of the base frame in a perpendicular direction and having an insertion hole of an identical shape as the insertion hole of the base frame, and a latching tab protruding from the other short edge of the base frame at an angle, and a latching groove and a latching ledge are formed on at least one of the two lateral surfaces positioned between the first and second lateral plates of the housing while facing each other which are adapted to be coupled to the latching tab.

18. The actuator module as claimed in claim 17, wherein the actuator module further comprises a fourth connection member, the fourth connection member comprising a base frame having the general shape of a rectangle with ears flared out at both sides of one of the short edges, the base frame having at least one insertion hole of an identical shape as the insertion holes of the actuator module, a fixing portion protruding perpendicularly from each ear and having an insertion hole of an identical shape as the insertion hole of the base frame, and a latching tab protruding from the other short edge of the base frame at an angle, and a latching groove and a latching ledge are formed on at least one of the two lateral surfaces positioned between the first and second lateral plates of the housing while facing each other which are adapted to be coupled to the latching tab.

19. The actuator module as claimed in claim 18, wherein the actuator module further comprises a fifth connection member, and the fifth connection member comprises a rectangular base frame having at least one insertion hole of an identical shape as the insertion holes of the actuator module and a side frame extending from each short edge of the base frame at a right angle so that the side frame protrudes in a direction perpendicular to the base frame, the side frame having at least one insertion hole of an identical shape as the insertion hole of the base frame.

20. The actuator module as claimed in claim 19, wherein a wiring opening and a wiring guide groove are formed on at least one of the two lateral surfaces positioned between the first and second lateral plates of the housing, such that wires connecting to the actuator contained in the housing enter the housing via the wiring opening, and the wiring guide groove guides the routing of the wiring so that the wires do not protrude out of the housing.
